(19) United States
(12) Patent Application Publication
(10) Pub. No.: US 2024/0089399 A1
(43) Pub. Date: Mar. 14, 2024

(54) INFORMATION PROCESSING APPARATUS, METHOD, AND STORAGE MEDIUM STORING PROGRAM OF APPLICATION FOR EXTENDING FUNCTIONS OF PRINTER DRIVER

(71) Applicant: CANON KABUSHIKI KAISHA, Tokyo (JP)

(72) Inventor: TETSUHIDE TAKASAKI, Tokyo (JP)

(21) Appl. No.: 18/464,934

(22) Filed: Sep. 11, 2023

(30) Foreign Application Priority Data
Sep. 14, 2022 (JP) 2022-146259

(51) Int. Cl. H04N 1/60; G06F 3/12

(52) U.S. Cl. CPC H04N 1/603; G06F 3/1204; G06F 3/1205; G06F 3/1206; G06F 3/123; G06F 3/1257; G06F 3/126; G06F 3/1274

(57) ABSTRACT

An information processing apparatus obtains information of a color profile managed by a printer driver and registers, in an operating system (OS), the obtained information of the color profile. The information processing apparatus changes a method of registration in the OS based on the obtained information of the color profile.

### BACKGROUND

### Technical Field

One disclosed aspect of the embodiments relates to an information processing apparatus, a method, and a storage medium for storing a program.

### Description of the Related Art

Image input/output devices, such as scanners, monitors, and printers, have a different color reproduction range for each type and model. Association of color signals between such devices, that is, association as to which color signal a predetermined color signal is converted into in the devices is performed using color profiles. Japanese Patent Laid-Open No. 2015-133661 describes a technique related to a method of controlling an image processing apparatus in which a color profile, which an Operating System (OS) references in order to perform color conversion processing, or an output condition corresponding to the color profile is appropriately updated.

### SUMMARY

One aspect of the embodiments provides a mechanism for appropriately registering color profile information in an OS even when a state in which the color profile information is not registered in the OS is entered for some reason.

The disclosure in one aspect provides a non-transitory computer-readable storage medium storing a program of an application for extending functions of a printer driver. The program is configured to cause a computer of an information processing apparatus to function as an obtaining unit, a registration unit, and a control unit. The obtaining unit is configured to obtain information of a color profile managed by the printer driver. The registration unit is configured to register, in an OS, the information of the color profile obtained by the obtaining unit. The control unit is configured to control the registration unit so as to change a method of registration in the OS based on the information of the color profile obtained by the obtaining unit.

According to the disclosure, it is possible to appropriately register color profile information in an OS even when a state in which the color profile information is not registered in the OS is entered for some reason.

Further features of the disclosure will become apparent from the following description of exemplary embodiments with reference to the attached drawings.

### BRIEF DESCRIPTION OF THE DRAWINGS

FIG. 1 is a block diagram illustrating a configuration of a printing system.

FIG. 2 is a block diagram illustrating a configuration of a host apparatus.

FIGS. 3A and 3B are diagrams illustrating color profile information.

FIG. 4 is a diagram illustrating a screen for displaying color profiles corresponding to a printer.

FIG. 5 is a diagram illustrating a printing screen of an image editing application.

FIG. 6 is a flowchart for explaining color profile re-registration control processing.

FIGS. 7A to 7C are diagrams illustrating a list of color profiles registered in an OS.

FIGS. 8A and 8B are diagrams illustrating file permissions of color profiles.

FIGS. 9A to 9C are diagrams illustrating screens for re-registering a print queue.

FIG. 10 is a flowchart for explaining color profile re-registration control processing.

FIG. 11 is a flowchart for explaining color profile re-registration control processing.

FIG. 12 is a flowchart for explaining color profile repair processing.

FIG. 13 is a flowchart for explaining print queue re-registration processing.

FIG. 14 is a flowchart for explaining color profile re-registration control processing.

FIGS. 15A and 15B are flowcharts for explaining print queue re-registration processing.

FIG. 16 is a diagram illustrating a re-registration print queue confirmation screen.

FIGS. 17A and 17B are diagrams illustrating user data.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made a disclosure that requires all such features, and multiple such features may be combined as appropriate. Furthermore, in the attached drawings, the same reference numerals are given to the same or similar configurations, and redundant description thereof is omitted. In the following, the term “unit” may have different meanings depending on the context. The usual meaning is an individual element, single and complete. The phrase “units of” may refer to a plurality of elements or a group of elements. In addition, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or program that, when executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials. Furthermore, depending on the context, the term “portion,” “part,” “device,” “switch,” or similar terms may refer to a circuit or a group of circuits. The circuit or group of circuits may include electronic, mechanical, or optical elements such as capacitors, diodes, transistors. For example, a switch is a circuit that turns on and turns off a connection. It can be implemented by a transistor circuit or similar electronic devices.

If a state in which color profile information is not registered in the OS is entered for some reason, the user cannot select, on an application, a color profile managed by a printer driver.

According to the present disclosure, it is possible to appropriately register color profile information in an OS even when a state in which the color profile information is not registered in the OS is entered for some reason.

### First Embodiment

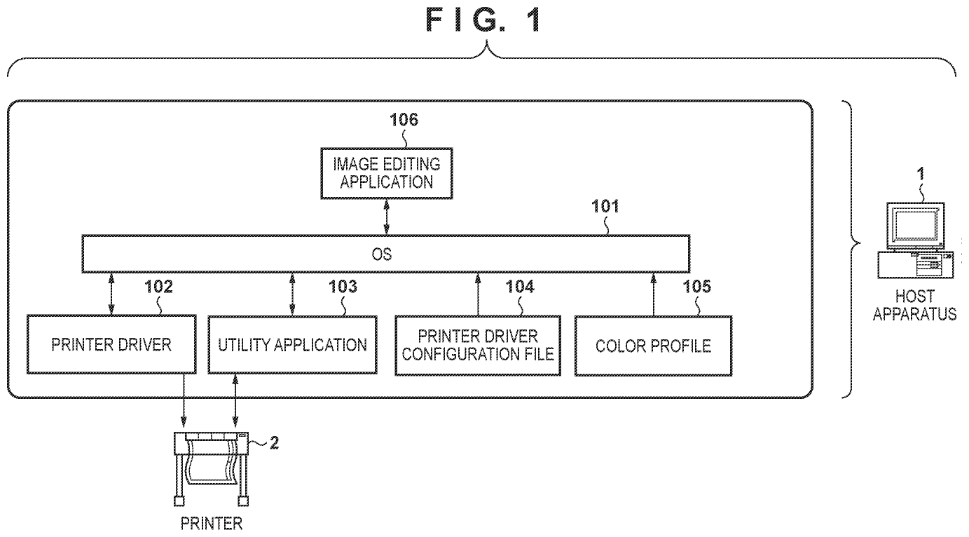

FIG. 1 is a block diagram illustrating an example of a configuration of a printing system according to the present embodiment. The printing system includes a host apparatus 1, such as a personal computer (PC), which is an information processing apparatus, and a printer 2, which is a printing apparatus. The printer 2 is an inkjet printer, which performs printing by an inkjet printing method in which ink droplets are discharged onto a printing medium. However, the printer 2 may be an electrophotographic printer or a sublimation printer. In addition, the printer 2 includes a rolled paper feeding unit (not illustrated) and can print an image of a size within a range allowed by a printer driver. In addition, the printer 2 includes a feeding port (not illustrated) for cut paper and can perform printing on cut paper.

An OS 101 and a printer driver 102, which is software for controlling the printer 2, are installed on the host apparatus 1. In addition, a printer driver configuration file 104 in which information of various settings of the printer driver 102 is stored is installed on the host apparatus 1. The information of various settings of the printer driver 102 is used to register the printer driver 102 in the OS 101. Furthermore, a utility application 103 is installed on the host apparatus 1. The utility application 103 is an application for extending functions of the printer driver 102. The utility application 103 includes, for example, a function by which the printer 2 obtains information related to printable printing media and print settings for the printing media are made selectable in the printer driver 102. The utility application 103 operates targeting the printer 2 which is associated with a print queue and a printer name registered in the OS 101. In addition, color profiles 105 for performing optimum color reproduction according to the type of printing medium to be printed by the printer 2 and an image editing application 106 for creating and editing various documents are installed on the host apparatus 1.

In the host apparatus 1, print processing of various documents created by the image editing application 106 is executed by the OS 101 and the printer driver 102 operating. In the present embodiment, description will be given assuming that the image editing application 106 is an application capable of color matching processing in which the color profiles 105 are used.

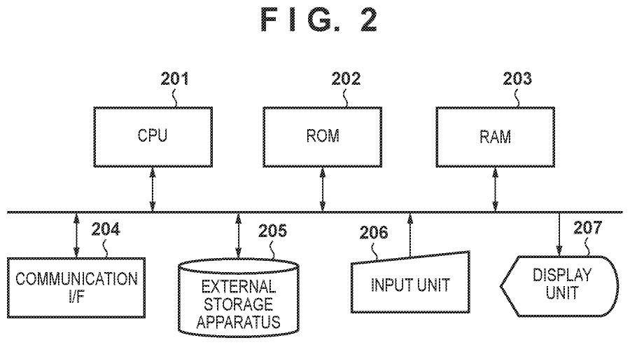

FIG. 2 is a block diagram illustrating an example of a configuration of the host apparatus 1. In FIG. 2, a CPU 201 is a processor that performs various types of control of the entire host apparatus 1. In a Read Only Memory (ROM) 202, an initialization program to be executed by the CPU 201 when the host apparatus 1 starts and various kinds of data are stored. A Random Access Memory (RAM) 203 is used as a main memory and a work region of the CPU 201. An external storage apparatus 205 is, for example, configured by a hard disk (HDD) or the like, and various programs are stored. Then, a program for realizing processing indicated in a flowchart, which will be described later, is loaded into the RAM 203 from the external storage apparatus (HDD) 205. The operation of the host apparatus 1 in the present embodiment is realized, for example, by the CPU 201 loading a program stored in the ROM 202 into the RAM 203 and executing the program.

The OS 101, the printer driver 102, the utility application 103, the printer driver configuration file 104, the color profiles 105, and the image editing application 106 are stored in the ROM 202 or the external storage apparatus 205. An input unit 206 is configured by a keyboard, a mouse, and the like and transmits operation information received from the user to the CPU 201. A display unit 207, which is configured by a liquid crystal display (LCD), a Cathode-Ray Tube (CRT) display, or the like, displays various user interface screens, which will be described later, according to control of the CPU 201. A communication interface 204 communicates with an external apparatus, such as the printer 2, according to control of the CPU 201.

The configuration of the host apparatus 1 is not limited to the configuration illustrated in FIG. 1 and any configuration that appropriately corresponds to functions that can be realized by a device to be used as the host apparatus 1 may be taken. In addition, the host apparatus 1 and the printer 2 may be directly connected or may be connected via another network device, such as a router.

Next, screens and a procedure until the color profiles 105 registered in the OS 101 are displayed on the image editing application 106 will be described. The color profiles 105 are managed by the printer driver 102. First, in order to cause the printer 2 to perform printing from the image editing application 106, a print queue in which the printer driver 102 and the printer 2 are associated is registered in the OS 101. In order to register a print queue in the OS 101, information of the printer driver configuration file 104 in which information of various settings of the printer driver 102 is stored is registered in the OS 101. In the printer driver configuration file 104, printing media supported by the printer driver 102, information of the color profiles 105 corresponding to various printing conditions, and the like are defined.

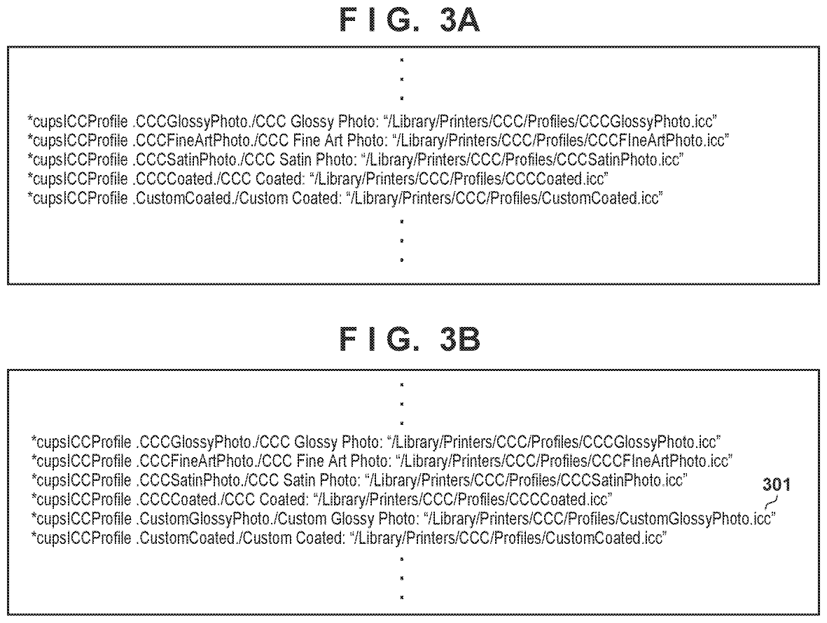

FIGS. 3A and 3B are diagrams illustrating examples of color profile information. The color profile information corresponds to printing conditions stored in the printer driver configuration file 104. Specifically, the color profiles 105 are specified corresponding to the types of printing media in the printing conditions to be set via the printer driver 102. As an example, description will be given with reference to the first line of FIG. 3A. Here, “CCC Glossy Photo” is set as the type of printing medium in the printing conditions. It is indicated that, in such a case, a file path of the corresponding color profile 105 on the OS 101 is “/Library/Printers/CCC/Profiles/CCCGlossyPhoto.icc”.

It is assumed that a print queue in which the printer driver 102 and the printer 2 are associated using the printer driver configuration file 104 illustrated in FIG. 1 is registered in the OS 101 as a printer name “CCC PRO Series”. This makes it possible to perform printing in the printer 2 from the image editing application 106 via the printer driver 102. In addition, in the OS 101, information of the color profiles 105 (hereinafter simply referred to as color profiles 105) defined in the printer driver configuration file 104 is registered.

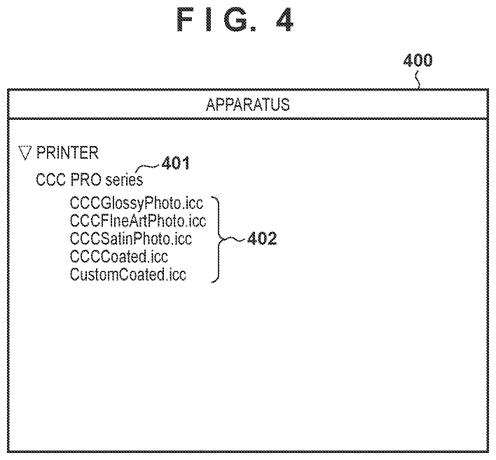

FIG. 4 is a diagram illustrating an example of a screen 400 indicating the color profiles 105, corresponding to a device (printer 2), registered in the OS 101. The screen 400 is a screen for displaying color profile registration information and is displayed by the OS 101. A printer name 401 is a printer name associated with a print queue registered in the OS 101. Color profiles 402 are a list of color profiles 105 stored in the printer driver configuration file 104, which has been used when registering a print queue. Here, it is assumed that five color profiles including “CCCGlossyPhoto.icc” are registered in the OS 101 as color profiles associated with a print queue of a printer name “CCC PRO Series”.

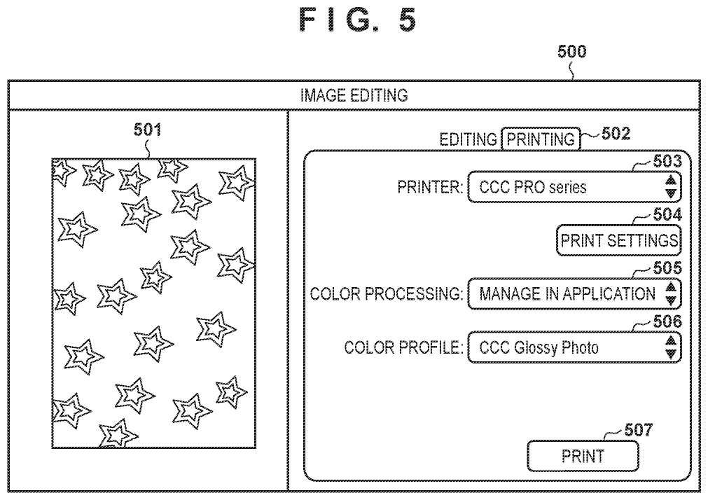

FIG. 5 is a diagram illustrating an example of a printing screen of the image editing application 106. A printing screen 500 is displayed by the image editing application 106. A display region 501 is a region in which a print target image selected or edited by the user is displayed. An operation menu 502 can receive, from a user, a selection of a menu for editing the image and a menu for printing the image. Here, it is assumed that a print menu is selected. A printer pop-up menu 503 displays a list of printer names of print queues registered in the OS 101. Here, it is assumed that “CCC PRO series” is selected. When a print settings button 504 is pressed, a print settings screen of the printer driver 102 associated with a printer name of a print queue selected in the printer pop-up menu 503 is displayed.

A color processing pop-up menu 505 is a menu for selecting whether to perform color matching processing for the print target image in the image editing application 106. The color processing pop-up menu 505 can receive, from the user, a selection of “manage in application” or “manage in printer driver”. When “manage in application” is selected, the image editing application 106 performs color matching processing on the print target image using the specified color profile and generates print data. When “manage in printer driver” is selected, the printer driver 102 set in the print settings screen or the OS 101 performs color matching processing on the print target image and generates print data. Here, it is assumed that “manage in application” is selected.

When “manage in application” is selected in the color processing pop-up menu 505, control of a color profile pop-up menu 506 is enabled. Using the color profile pop-up menu 506, the user can select a color profile for the time of color matching processing. The color profiles displayed in the color profile pop-up menu 506 include color profiles managed by the image editing application 106 and color profiles registered in the OS 101. The image editing application 106 obtains the color profiles registered in the OS 101 by calling an application program interface (API) provided by the OS 101 and displays the color profiles in the color profile pop-up menu 506. When a print button 507 is pressed, the print target image is printed in the printer 2 via the printer driver 102 according to the above-described color matching processing and the print settings.

Normally, in the OS 101, security measures for preventing files from being lost or rewritten without permission or unauthorized programs from being executed due to unintended software being installed are taken. For example, if file attributes and file formats of color profiles created by the user and managed by the printer driver 102 do not satisfy requirements of the OS 101, color profile information cannot be registered in the OS 101. In addition, even if color profiles are successfully registered when a print queue is registered, the requirements of the OS 101 may change after an upgrade or the like of the OS 101. In such a case, color profile information registered in the OS 101 may be deleted. When color profile information is deleted, even if the printer name 401 is selected in the screen 400, the color profile information will not be displayed. As a result, the user cannot select, from the image editing application 106, a color profile, for optimum color reproduction, corresponding to the type of printing medium to be printed by the printer 2.

Therefore, in the present embodiment, even when a state in which color profiles are not registered in the OS 101 is entered for some reason, control is performed such that the user can select, on the image editing application 106, the color profile 105 managed by the printer driver 102. A control method thereof will be described below.

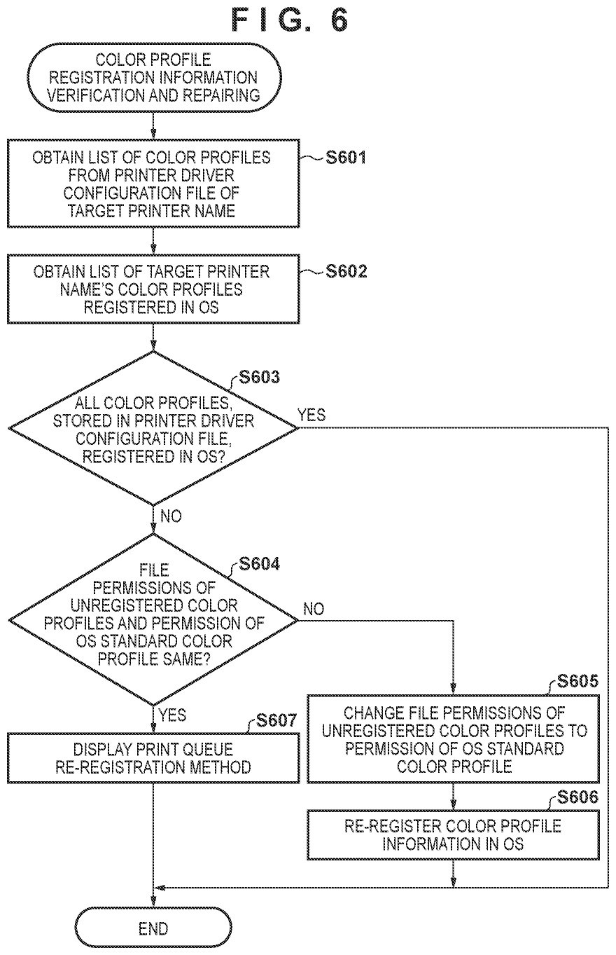

When the OS 101 is updated, the user starts the utility application 103. By starting the utility application 103, color profile registration state verification and re-registration processing indicated in FIG. 6 is started. The processing of FIG. 6 is realized, for example, by the CPU 201 loading a program stored in the ROM 202 into the RAM 203 and executing the program. In the present embodiment, when it is determined that color profiles are not registered in the OS 101 according to the processing of FIG. 6, the color profiles can be re-registered.

In step S601, the utility application 103 obtains a list of color profiles 105 from the printer driver configuration file 104 corresponding to a print queue of a target printer name. For example, the list of color profiles 105 is obtained from the printer driver configuration file 104 of the printer name “CCC PRO series”. Here, it is assumed that five color profiles including the color profile “CCCGlossy Photo.icc” stored in the printer driver configuration file 104 of FIG. 3A are obtained.

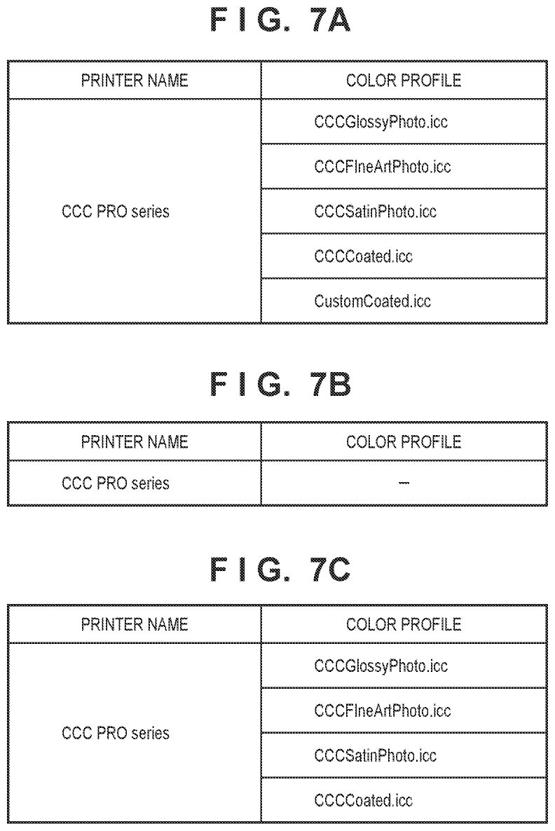

In step S602, the utility application 103 obtains a list of color profiles, corresponding to the target printer name, registered in the OS 101. The utility application 103 obtains the color profiles of the printer name “CCC PRO series”, registered in the OS 101, by calling an API provided by the OS 101. Here, it is assumed that color profiles indicated in FIG. 7A are obtained.

In step S603, the utility application 103 determines whether all color profiles defined in the printer driver configuration file 104 are registered in the OS 101. In a case of this example, all five color profiles including “CCCGlossy Photo.icc” of FIG. 3A are included in the color profiles of FIG. 7A. In such a case, in step S603, it is determined that all color profiles defined in the printer driver configuration file 104 are registered in the OS 101, and the processing of FIG. 6 ends.

Here, a case in which color profiles of FIG. 7B are obtained in step S602 as a list of color profiles registered in the OS 101 will be described. That is, the case corresponds to when all color profiles stored in the printer driver configuration file 104 could not be obtained from the OS 101. In such a case, in step S603, it is determined that all color profiles defined in the printer driver configuration file 104 are not registered in the OS 101, and the processing proceeds to step S604.

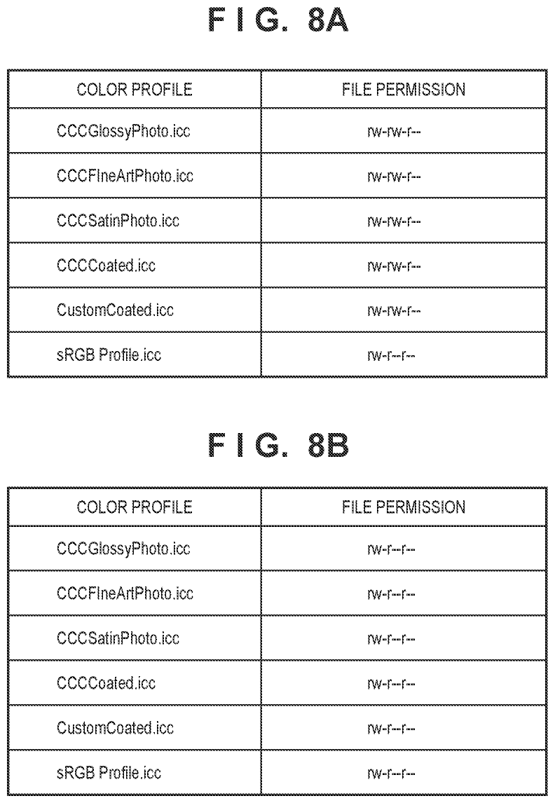

In step S604, the utility application 103 determines whether file permissions of color profiles not registered in the OS 101 and a file permission of an OS standard color profile are the same. Here, it is assumed that the file permissions of color profiles not registered in the OS 101 and the file permission of the OS standard color profile are as illustrated in FIG. 8A. That is, from the top of FIG. 8A, “CCCGlossyPhoto.icc” to “CustomCoated.icc” are color profiles not registered in the OS 101. “sRGB Profile.icc” of FIG. 8A is an OS standard color profile.

The utility application 103 obtains a file permission, such as a file owner, a file owner group, and a non-owner, by a built-in command of the OS 101 or by calling an API provided by the OS 101. In addition, the OS standard color profile is, for example, an sRGB color profile (sRGB Profile.icc), which is a standard display profile, included in the OS 101. The utility application 103 obtains a file path of the OS standard color profile by calling an API provided by the OS 101.

The determination processing of step S604 is, in other words, processing for determining whether the reason for color profiles not being registered in the OS 101 is due to file permissions of the color profiles. In a case of this example, the file permissions of all color profiles not registered in the OS 101 are “rw-rw-r--”, and the file permission of the OS standard color profile is “rw-r--r--”. That is, it is determined that the file permissions of all color profiles not registered in the OS 101 are different from the file permission of the OS standard color profile, and the processing proceeds to step S605.

In step S605, the utility application 103 changes the file permissions of color profiles not registered in the OS 101 to the file permission of the OS standard color profile. In a case of this example, the file permissions of all color profiles not registered in the OS 101 are changed to “rw-r--r--”, which is the file permission of the OS standard color profile “sRGB Profile.icc”. The utility application 103 changes the file permissions by a built-in command of the OS 101 or by calling an API provided by the OS 101.

In step S606, the utility application 103 re-registers the color profiles in the OS 101. In a case of this example, the utility application 103 re-registers, in the OS 101, all color profiles not registered in the OS 101 as color profiles of a print queue corresponding to the printer name “CCC PRO series”. This re-registration is performed, for example, by the utility application 103 calling an API provided by the OS 101. After step S606, the processing of FIG. 6 ends.

As described above, according to the present embodiment, when the reason for color profiles not being registered in the OS 101 is due to file permissions, the file permissions of color profiles not registered in the OS 101 is changed, and the color profiles are re-registered in the OS 101. With such a configuration, the user can select, on the image editing application 106, the color profile 105 managed by the printer driver 102.

Here, it is assumed that permissions of color profiles not registered in the OS 101 and the OS standard color profile are as illustrated in FIG. 8B. That is, from the top of FIG. 8B, “CCCGlossyPhoto.icc” to “CustomCoated.icc” are color profiles not registered in the OS 101. “sRGB Profile.icc” of FIG. 8B is an OS standard color profile. In a case of this example, the file permissions of all color profiles not registered in the OS 101 and the file permission of the OS standard color profile are the same. In such a case, it is determined that the reason for color profiles not being registered in the OS 101 is due to print queue registration processing, and the processing proceeds from step S604 to step S607.

In step S607, the utility application 103 displays a print queue re-registration screen.

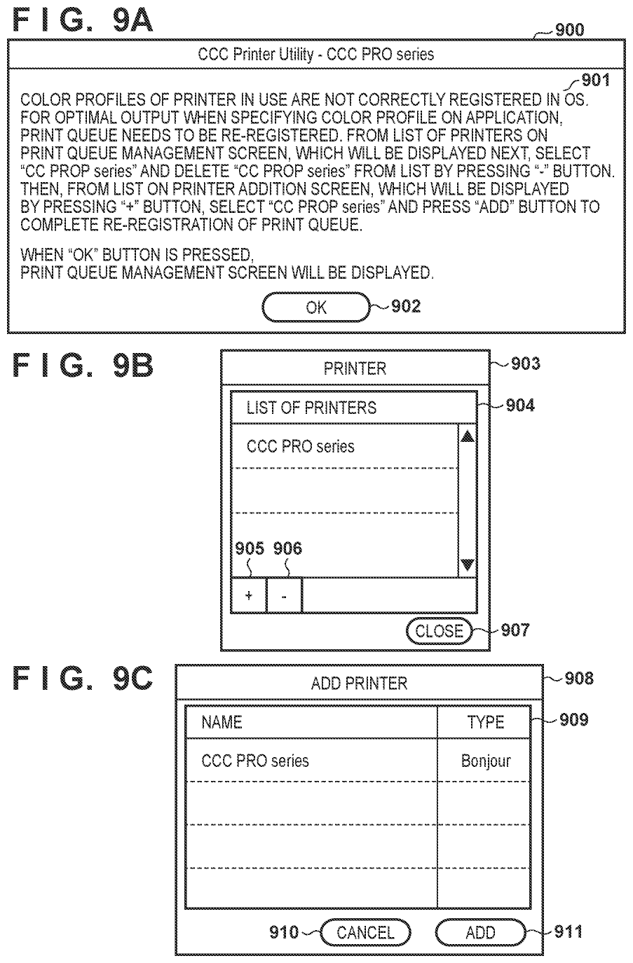

FIG. 9A is a diagram illustrating an example of a print queue re-registration screen 900 displayed by the utility application 103. In the print queue re-registration screen 900, a procedure for print queue re-registration is displayed in a display region 901. When an OK button 902 is pressed, the utility application 103 closes the print queue re-registration screen 900 and displays a print queue management screen 903, provided by the OS 101, illustrated in FIG. 9B. In the print queue management screen 903, a list of print queues currently registered in the OS 101 is displayed as a printer list 904. When a printer addition screen display button 905 is pressed, the utility application 103 closes the print queue management screen 903 and displays a printer addition screen 908, provided by the OS 101, illustrated in FIG. 9C. When a print queue delete button 906 is pressed, the print queue selected in the printer list 904 is deleted. When a close button 907 is pressed, the utility application 103 closes the print queue management screen 903. In the printer addition screen 908, a list of available printers 2 connected to the host apparatus 1 are displayed as an available printer list 909. When a cancel button 910 is pressed, the utility application 103 closes the printer addition screen 908 without performing printer addition processing. When a print queue add button 911 is pressed, the utility application 103 registers, in the OS 101, the print queue of the printer selected in the available printer list 909 and closes the printer addition screen 908.

As described above, the user re-registers the print queue in the print queue management screen 903 and the printer addition screen 908 according to the procedure for print queue re-registration displayed in the display region 901. This makes it possible for the user to select, on the image editing application 106, the color profile 105 managed by the printer driver 102.

In the present embodiment, it has been described that when the reason for color profiles not being registered in the OS 101 is due to file permissions, color profile information is re-registered using an API provided by the OS 101. However, a configuration may be taken so as to, in such a case, re-register the color profile information by re-registering a print queue. In addition, it has been described that when the reason for color profiles not being registered in the OS 101 is due to print queue registration processing, a print queue is re-registered by a user operation. However, a configuration may be taken so as to, in such a case, re-register the color profile information by using an API provided by the OS.

As described above, when color profiles are not registered in the OS, by executing processing according to the reason for them not being registered, it becomes possible for the user to select, on the application, a color profile managed by the printer driver.

### Second Embodiment

Hereinafter, a second embodiment will be described regarding points of difference from the first embodiment. In the first embodiment, a case where all color profiles defined in the printer driver configuration file 104 are not registered in the OS 101 has been described. In the present embodiment, a case where some color profiles defined in the printer driver configuration file 104 are not registered in the OS 101 will be described.

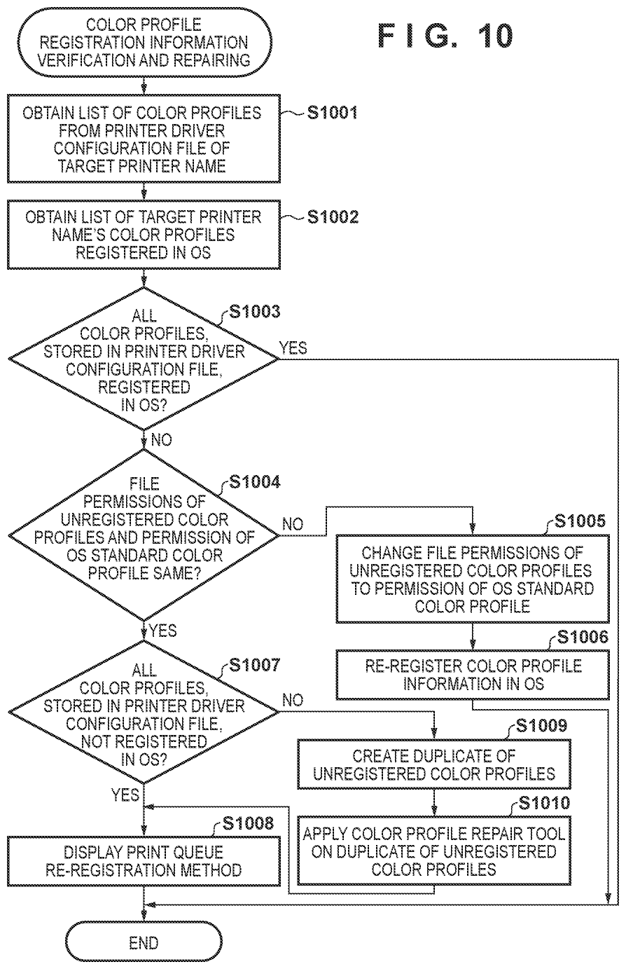

FIG. 10 is a flowchart illustrating color profile registration state verification and re-registration processing according to the present embodiment. The processing of FIG. 10 is realized, for example, by the CPU 201 loading a program stored in the ROM 202 into the RAM 203 and executing the program. Since step S1001 to step S1006 and step S1008 of FIG. 10 are the same as the description of step S601 to step S606 and step S607 of FIG. 6, the description thereof will be omitted.

In the present embodiment, as one example, description will be given assuming that, in step S1002, color profiles indicated in FIG. 7C have been obtained as color profiles registered in the OS 101. In addition, description will be given assuming that the file permissions of color profiles not registered in the OS 101 and the file permission of the OS standard color profile are as illustrated in FIG. 8B. That is, “CustomCoated.icc” in FIG. 8B is a color profile not registered in the OS 101. “sRGB Profile.icc” of FIG. 8B is the OS standard color profile.

As described in step S603, in step S1003 it is determined whether all color profiles defined in the printer driver configuration file 104 are registered in the OS 101. In a case of this example, “CustomCoated.icc” is not registered; thus, the processing proceeds to step S1004.

As described in step S604, in step S1004, it is determined whether the file permissions of color profiles not registered in the OS 101 are the same as the file permission of the OS standard color profile. In a case of this example, as indicated in FIG. 8B, the file permissions of color profiles not registered in the OS 101 and the file permission of the OS standard color profile are the same; thus, the processing proceeds to step S1007.

In step S1007, the utility application 103 determines whether all color profiles defined in the printer driver configuration file 104 are not registered in the OS 101. If all the color profiles are not registered in the OS 101, it is expected that it is in some way due to print queue registration processing. Meanwhile, if some color profiles are not registered, it is predicted that formats of color profiles are not compatible with the requirements of the OS 101. In a case of this example, only “CustomCoated.icc” is not registered; thus, the processing proceeds to step S1009. If it is determined that all color profiles are not registered in the OS 101, the processing proceeds to step S1008 similarly to the first embodiment.

In step S1009, the utility application 103 creates a duplicate of color profiles not registered in the OS 101. The utility application 103 creates a duplicate of color profiles not registered in the OS 101 by a built-in command of the OS 101 or by calling an API provided by the OS 101.

In step S1010, the utility application 103 applies a color profile repair tool on the duplicate of the color profiles not registered in the OS 101 created in step S1009. Here, the color profile repair tool is an executable file provided by the OS 101 and has a function for determining whether a format of a color profile is a format that satisfies the requirements of the OS 101. Then, when a color profile is specified as an input parameter, the color profile repair tool changes a format of a color profile to a format that satisfies the requirements of the OS 101. By this, a color profile of a color profile format not compatible with the requirements of the OS 101 is converted to a color profile of a color profile format compatible with the requirements of the OS 101.

The processing proceeds to step S1008, and similarly to the first embodiment, the utility application 103 displays the print queue re-registration screen 900 illustrated in FIG. 9A and then ends the processing of FIG. 10. By the user re-registering a print queue in step S1008 according to the displayed procedure for re-registering a print queue, it becomes possible for the user to select, on the image editing application 106, the color profile 105 managed by the printer driver 102.

It is expected that a color profile created by the user for a special purpose will be in a color profile format not compatible with the requirements of the OS 101. It is also expected that when the color profile repair tool is applied to such a color profile, the color profile cannot be used for the special purpose. Therefore, in the present embodiment, by creating a duplicate of color profiles not registered in the OS 101, the user can use the original color profile for the special purpose.

In the present embodiment, it is has been described that the formats of color profiles are converted to formats compatible with the requirements of the OS 101 by executing the color profile repair tool. In the present embodiment, a configuration may be taken such that the utility application 103 displays, to the user, a method of using the color profile repair tool. In such a case, the user converts the formats of color profiles according to the displayed usage method and then registers a print queue.

As described above, even when some color profiles are not registered in the OS, by executing processing according to the reason for them not being registered, it becomes possible for the user to select, on the application, a color profile managed by the printer driver.

### Third Embodiment

Hereinafter, a third embodiment will be described regarding points of difference from the first and second embodiments. In the present embodiment, a case where color profile format conversion is not performed even when the color profile repair tool is executed and a case where user data related to a print queue is present will be described.

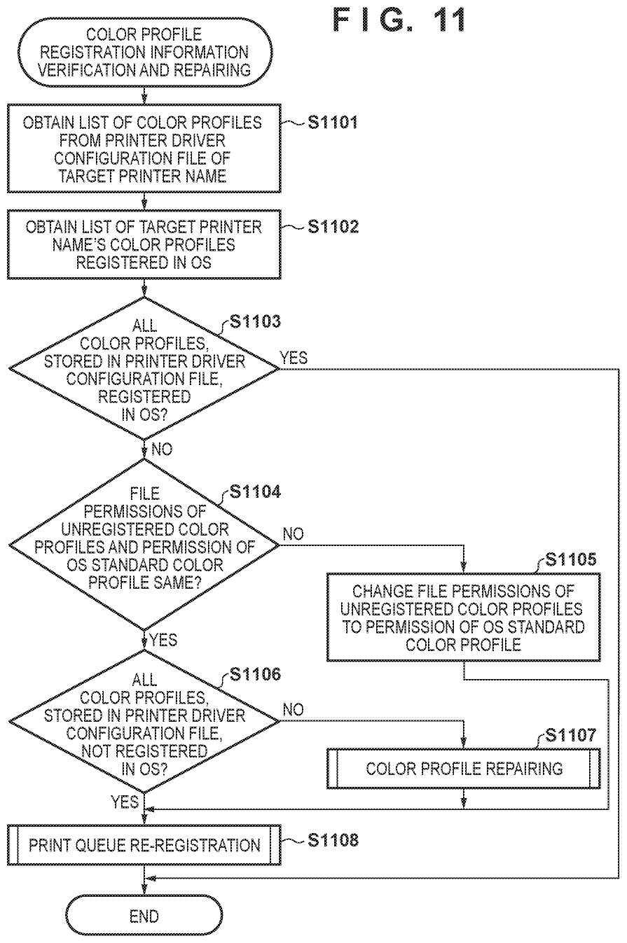

FIG. 11 is a flowchart illustrating color profile registration state verification and re-registration processing according to the present embodiment. The processing of FIG. 11 is realized, for example, by the CPU 201 loading a program stored in the ROM 202 into the RAM 203 and executing the program. Since step S1101 to step S1105 of FIG. 11 are the same as the description of step S601 to step S605 of FIG. 6, the description thereof will be omitted.

As described in step S601, in step S1101, a list of color profiles is obtained from the printer driver configuration file 104 illustrated in FIG. 3B. Then, as described in step S602, in step S1102, a list of a target printer name's color profiles not registered in the OS 101 is obtained. Here, it is assumed that color profiles indicated in FIG. 7C are obtained.

As described in step S603, in step S1103, it is determined whether all color profiles defined in the printer driver configuration file 104 are registered in the OS 101. In a case of this example, “CustomGlossyPhoto.icc” and “CustomCoated.icc” are not registered; thus, the processing proceeds to step S1004.

As described in step S604, in step S1104, it is determined whether the file permissions of color profiles not registered in the OS 101 are the same as the file permission of the OS standard color profile. In the present embodiment, it is assumed that the file permissions of color profiles not registered in the OS 101 and the file permission of the OS standard color profile are as illustrated in FIG. 8B. In a case of this example, the file permissions of color profiles not registered in the OS 101 and the file permission of the OS standard color profile are the same; thus, the processing proceeds to step S1106.

In step S1106, the utility application 103 determines whether all color profiles defined in the printer driver configuration file 104 are registered in the OS 101. When it is determined that all color profiles defined in the printer driver configuration file 104 are not registered in the OS 101, the processing proceeds to step S1108. In a case of this example, some color profiles, “CustomGlossyPhoto.icc” and “CustomCoated.icc”, are not registered. Therefore, it is determined that formats of color profiles are not compatible with the requirements of the OS 101, and in step S1107, the utility application 103 executes color profile repair processing.

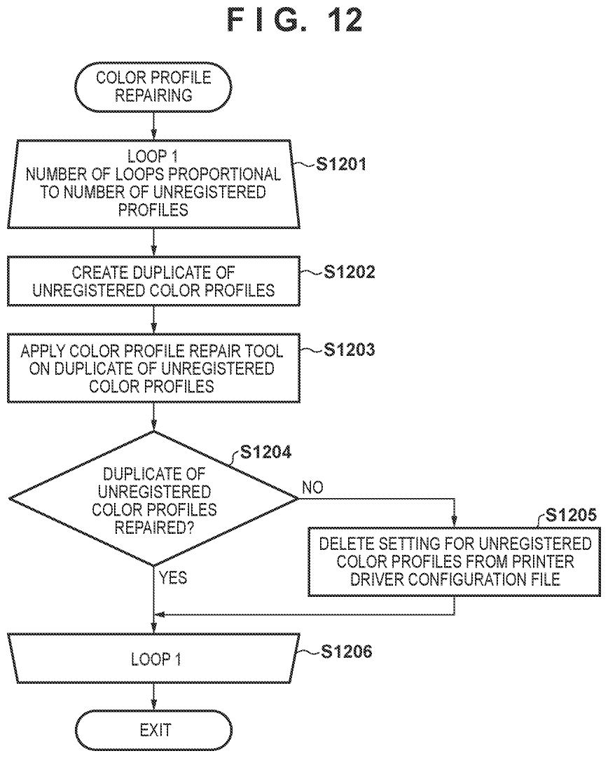

FIG. 12 is a flowchart for explaining color profile repair processing of step S1107. In step S1201, the utility application 103 sets the number of loops for the processing. The utility application 103 sets the number of color profiles not registered in the OS 101 as the number of loops. In a case of this example, the aforementioned two color profiles are not registered in the OS 101; thus, two loops are set. The order of processes may be arbitrary, and in this example, a color profile, not registered in the OS 101, to be a target of the first loop is set to be “CustomGlossyPhoto.icc”.

Similarly to step S1009 of FIG. 10, in step S1202, the utility application 103 creates a duplicate of the color profile not registered in the OS 101. Then, similarly to step S1010 of FIG. 10, in step S1203 the utility application 103 applies the color profile repair tool on the duplicate of the color profile not registered in the OS 101 created in step S1202.

In step S1204, the utility application 103 determines whether the duplicate of color profiles not registered in the OS 101 has been repaired by the color profile repair tool executed in step S1203. If it is determined that the duplicate has been repaired (repair is successful), the processing proceeds to step S1206. Meanwhile, if it is determined that the duplicate has not been repaired (repair is unsuccessful), the processing proceeds to step S1205. For example, when there is a difference between the color profiles before and after the duplication upon comparing them for difference, the utility application 103 determines that the duplicate of the color profile not registered in the OS 101 has been repaired. In a case of this example, it is assumed that the color profile “CustomGlossyPhoto.icc” has not been repaired, and the processing proceeds from step S1204 to step S1205.

In step S1205, the utility application 103 deletes, from the printer driver configuration file 104, the color profile not registered in the OS 101. For example, the utility application 103 deletes the line 301 of the printer driver configuration file illustrated in FIG. 3B. In other words, it can be said the deletion processing of step S1205 is processing for excluding a color profile from being a target of control of the printer driver 102.

In step S1206, the utility application 103 starts the next loop processing of step S1201. The color profile, not registered in the OS 101, to be a target of the second loop is “CustomCoated.icc”. Similarly for “CustomCoated.icc”, steps S1202 and S1203 are performed. For “CustomCoated.icc”, in step S1204, it is assumed that the duplicate of the color profile not registered in the OS 101 has been repaired. In such a case, the processing proceeds to step S1206, and the loop processing ends. After the end of loop processing, the processing proceeds to step S1108 of FIG. 11. In step S1108, the utility application 103 executes print queue re-registration processing.

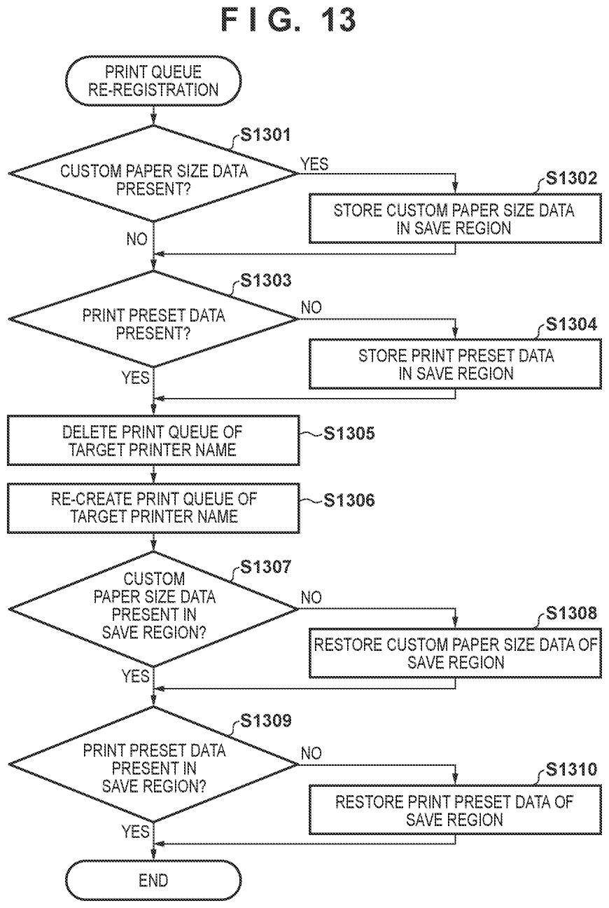

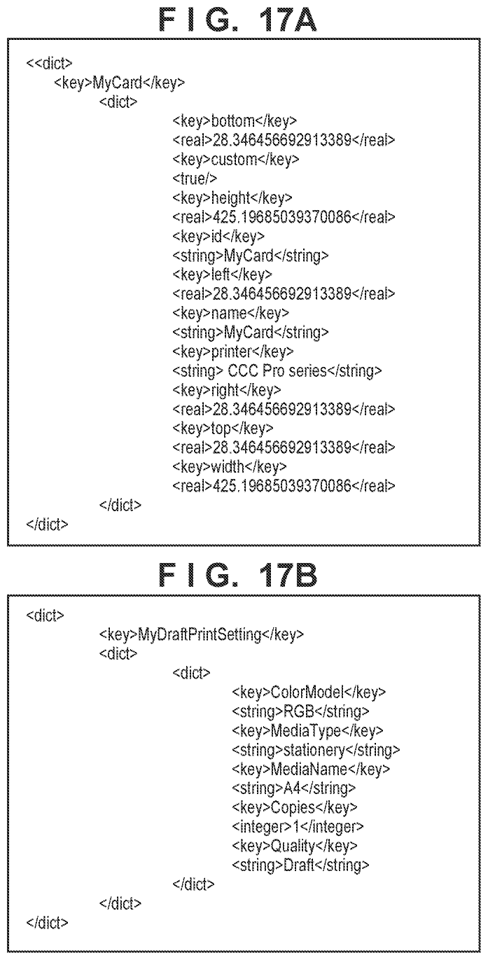

FIG. 13 is a flowchart for explaining print queue re-registration processing according to the present embodiment. In step S1301, the utility application 103 determines whether custom paper size data created by a user associated with a print queue is present. Here, the custom paper size data is data in which the user registered, via the OS 101, a paper size that the user wishes to use aside from paper sizes provided by the printer driver 102. The custom paper size data is managed by the OS 101 and stored in a user storage region associated with a print queue. If it is determined that custom paper size data is present, the processing proceeds to step S1302. Meanwhile, if it is determined that custom paper size data is not present, the processing proceeds to step S1303. FIG. 17A is a diagram illustrating an example of custom paper size data registered by the user. Here, it is assumed that it is determined that the custom paper size data of FIG. 17A is present.

In step S1302, the utility application 103 moves out the custom paper size data from a user storage region to a save region. Here, the save region is a storage region that is not managed by the OS 101. When deleting a print queue of a target printer name, the custom paper size data created by the user is also deleted from the user storage region. Therefore, in the present embodiment, the custom paper size data is temporarily moved out to the save region not managed by the OS 101. After step S1302, the processing proceeds to step S1303.

In step S1303, the utility application 103 determines whether print preset data created by the user associated with the print queue is present. Here, the print preset data is data in which the user has set desired print settings of the printer driver 102 via the OS 101. The print preset data is managed by the OS 101 and stored in a user storage region associated with the print queue. If it is determined that print preset data is present, the processing proceeds to step S1304. Meanwhile, if it is determined that print preset data not present, the processing proceeds to step S1305. FIG. 17B is a diagram illustrating an example of print preset data registered by the user. Here, it is assumed that it is determined that the print preset data of FIG. 17B is present.

In step S1304, the utility application 103 moves out the print preset data from a user storage region to a save region. Here, the save region is a storage region that is not managed by the OS 101. When deleting a print queue of a target printer name, the print preset data created by the user is also deleted from the user storage region. Therefore, in the present embodiment, the print preset data is temporarily moved out to the save region not managed by the OS 101. After step S1304, the processing proceeds to step S1305.

In step S1305, the utility application 103 deletes the print queue of the target printer name. For example, the utility application 103 deletes a print queue of the target printer name “CCC PRO series” using an API provided by the OS 101 for deleting a print queue. By deleting the print queue, the custom paper size data and print preset data stored in the user storage region managed by the OS 101 are also deleted.

In step S1306, the utility application 103 re-registers the print queue of the target printer name. For example, the utility application 103 creates the print queue of a target printer name “CCC PRO series” using an API provided by the OS 101 for creating a print queue.

In step S1307, the utility application 103 determines whether custom paper size data is present in a save region. If it is determined that custom paper size data is present in a save region, the processing proceeds to step S1308. If it is determined that custom paper size data is not present in a save region, the processing proceeds to step S1309. In a case of this example, it is determined that custom paper size data is present in a save region; thus, the processing proceeds to step S1308.

In step S1308, the utility application 103 restores the custom paper size data stored in the save region to the user storage region managed by the OS 101. After step S1308, the processing proceeds to step S1309.

In step S1309, the utility application 103 determines whether print preset data is present in a save region. If it is determined that print preset data is present in a save region, the processing proceeds to step S1310. If it is determined that print preset data is not present in a save region, the processes of FIGS. 13 and 11 end. In a case of this example, it is determined that print preset data is present in a save region; thus, the processing proceeds to step S1310.

In step S1310, the utility application 103 restores the print preset data stored in the save region to the user storage region managed by the OS 101. Then, the processes of FIGS. 13 and 11 end.

In the present embodiment, a configuration in which color profiles for which formats of color profiles are not converted even when the color profile repair tool is executed are removed from a printer driver configuration file and a print queue is re-registered has been described. With such a configuration, the printer driver configuration file can be made not to include color profiles that do not satisfy the requirements of the OS. In addition, a configuration in which, when user data related to a print queue is present, the user data is moved out before print queue re-registration and restored after print queue re-registration has been described. With such a configuration, it is possible to prevent user data from being lost due to a print queue being re-registered.

As described above, when color profiles are not registered in the OS, by executing processing according to the reason for them not being registered, it becomes possible for the user to select, on the application, a color profile managed by the printer driver.

### Fourth Embodiment

Hereinafter, a fourth embodiment will be described regarding points of difference from the first to third embodiments. In the present embodiment, a case where all the color profiles defined in the printer driver configuration file 104 are not registered in the OS and, further, a plurality of print queues are registered in the OS 101 will be described.

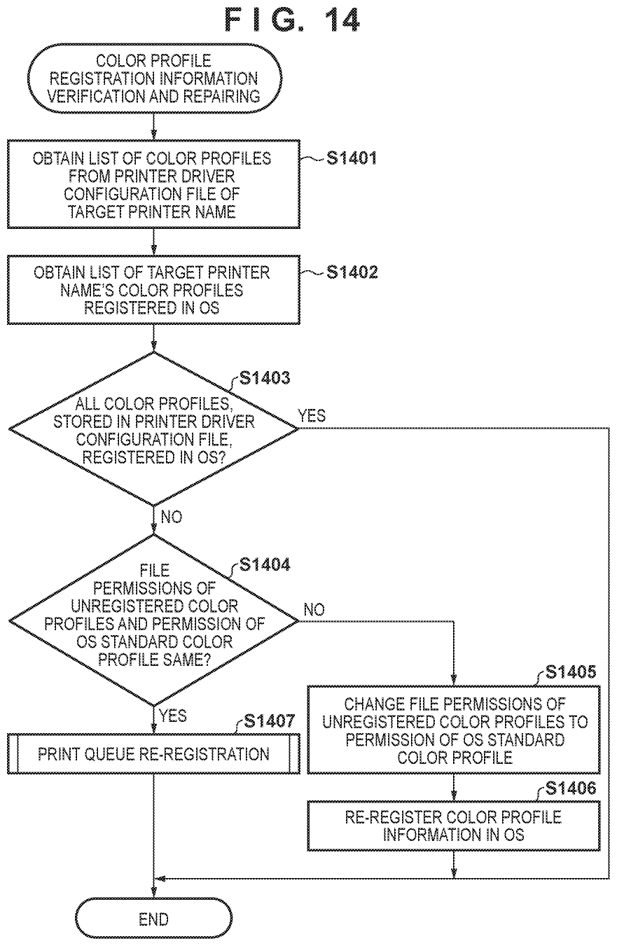

FIG. 14 is a flowchart illustrating color profile registration state verification and re-registration processing according to the present embodiment. The processing of FIG. 14 is realized, for example, by the CPU 201 loading a program stored in the ROM 202 into the RAM 203 and executing the program. Since step S1401 to step S1406 of FIG. 14 are the same as the description of step S601 to step S606 of FIG. 6, the description thereof will be omitted.

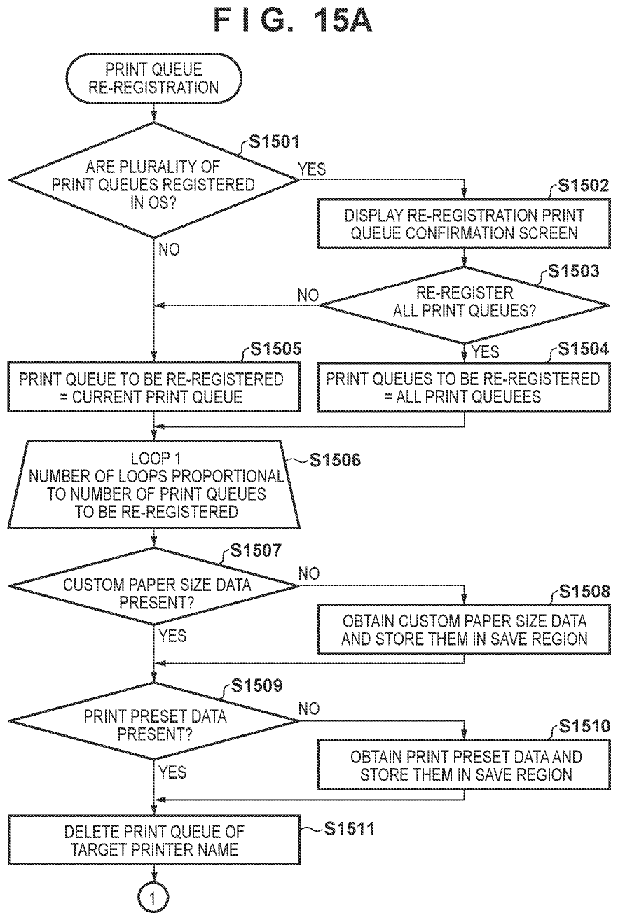

As described in step S601, in step S1401, a list of color profiles 105 is obtained from the printer driver configuration file 104, which corresponds to a print queue of a target printer name. Here, it is assumed that color profiles stored in the printer driver configuration file 104 of FIG. 3A is obtained. As described in step S602, in step S1402, a list of the target printer name's color profiles not registered in the OS 101 is obtained. Here, it is assumed that color profiles of FIG. 7B are obtained as color profiles not registered in the OS 101 will be described. In addition, description will be given assuming that the file permissions of color profiles not registered in the OS 101 and the file permission of the OS standard color profile are as illustrated in FIG. 8B. In a case of this example, the processing proceeds from step S1403 to step S1404, and since the file permissions of color profiles not registered in the OS 101 and the file permission of the OS standard color profile are the same, the processing proceeds to step S1407. In the present embodiment, in step S1407, the print queue re-registration processing indicated in FIGS. 15A and 15B is executed.

FIGS. 15A and 15B are flowcharts for explaining print queue re-registration processing according to the present embodiment. First, in step S1501, the utility application 103 determines whether a plurality of print queues are registered in the OS 101. The utility application 103 obtains the print queues registered in the OS 101 using an API for obtaining registered print queues provided by the OS 101. If it is determined that there is one obtained print queue, that is, only the current print queue for which the color profiles are obtained in FIG. 14, the processing proceeds to step S1505. In step S1505, the utility application 103 decides the current print queue as the print queue to be re-registered. Meanwhile, if it is determined that there are a plurality of obtained print queues, the processing proceeds to step S1502. Here, the following description will be continued assuming that a total of two print queues whose printer names are “CCC PRO Series 1” and “CCC PRO Series 2” are obtained.

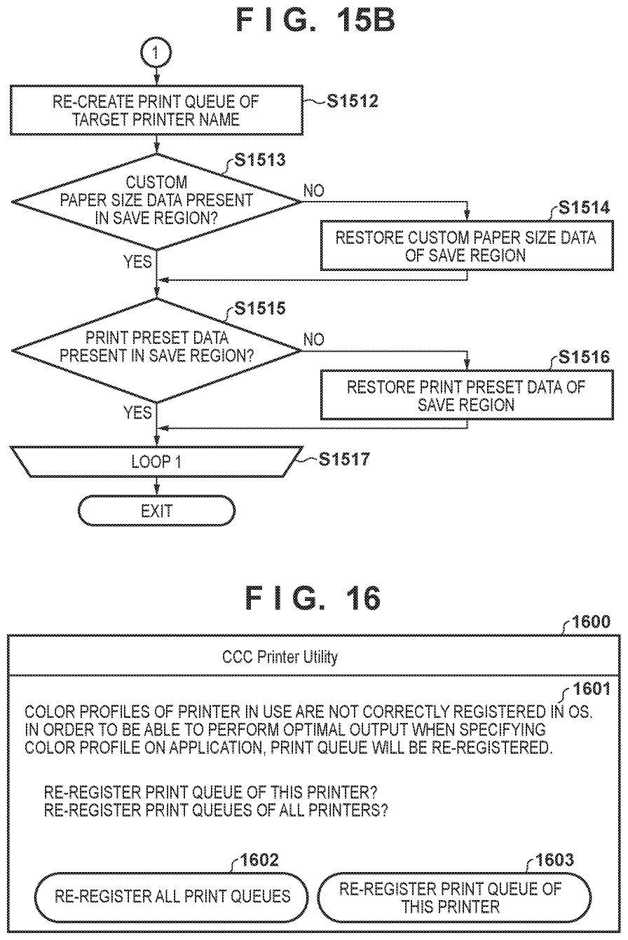

In step S1502, the utility application 103 displays a re-registration print queue confirmation screen 1600 illustrated in FIG. 16. FIG. 16 is a diagram illustrating an example of the re-registration print queue confirmation screen 1600. A display region 1601 is a region in which a descriptive message to the user is displayed. In the message region 1601, a message prompting a selection as to whether to re-register only the current print queue or re-register all printer queues is displayed. A button 1602 is a button for receiving an instruction for re-registering all print queues, and a button 1603 is a button for receiving an instruction for re-registering only the current print queue. When the user presses the button 1602, the processing proceeds to step S1504, and when the user presses the button 1603, the processing proceeds to step S1505.

In step S1504, the utility application 103 decides all print queues registered in the 101 as print queues to be re-registered. In this example, the user presses the button 1602 and the processing of step S1504 is executed.

In step S1506, the utility application 103 sets the number of loops for the subsequent processing. The utility application 103 sets the number of print queues registered in the OS 101 as the number of loops. In a case of this example, the aforementioned two print queues are registered; thus, two loops are set. The order of processes may be arbitrary, and in this example, it is assumed that a printer name of a print queue to be re-registered in the first loop processing is “CCC PRO series 1”. Then, the utility application 103 executes the processing of step S1507 to step S1516. Since step S1507 to step S1516 are the same as the description of step S1301 to step S1310 of FIG. 13, the description thereof will be omitted. In a case of this example, the print queue of the printer name “CCC PRO series 1” is re-registered in the first loop processing, and the print queue of the printer name “CCC PRO series 2” is re-registered in the second loop processing. Then, in step S1517, the loop processing ends. After the end of loop processing, the processes of FIGS. 15 and 14 end.

If all of the color profile information registered in the OS 101 is not registered and it is expected that it is in some way due to print queue registration processing, it is expected that all of the color profile information is similarly not registered for other print queues registered in the OS 101. In the present embodiment, in such a case, all the print queues registered in the OS 101 can be re-registered. As a result, it is possible for the user to have, as targets of selection on the application, color profiles managed by all the printer drivers.

As described above, when color profiles are not registered in the OS, by executing processing according to the reason for them not being registered, it becomes possible for the user to select, on the application, a color profile managed by the printer driver.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-146259, filed Sep. 14, 2022, which is hereby incorporated by reference herein in its entirety.

What is claimed is:

1. A non-transitory computer-readable storage medium storing a program of an application for extending functions of a printer driver, the program configured to cause a computer of an information processing apparatus to function as:
an obtaining unit configured to obtain information of a color profile managed by the printer driver;
a registration unit configured to register, in an operating system (OS), the information of the color profile obtained by the obtaining unit; and
a control unit configured to control the registration unit so as to change a method of registration in the OS based on the information of the color profile obtained by the obtaining unit.

2. The storage medium according to claim 1, wherein the control unit controls the registration unit so as to change the method of registration in the OS according to whether the information of the color profile obtained by the obtaining unit satisfies conditions.

3. The storage medium according to claim 2, wherein the conditions include a first condition indicating that a file permission indicated in the information of the color profile obtained by the obtaining unit and a file permission of a standard color profile used in the OS are the same.

4. The storage medium according to claim 3, wherein in a case where the first condition is not satisfied, the control unit controls the registration unit so as to change the file permission of the color profile indicated in the information of the color profile obtained by the obtaining unit to the file permission of the standard color profile and register, in the OS, the information of the color profile whose file permission has been changed.

5. The storage medium according to claim 2, wherein the conditions include a second condition indicating that all of information of a plurality of color profiles obtained by the obtaining unit is registered in the OS.

6. The storage medium according to claim 5, wherein in a case where the second condition is not satisfied, regarding a color profile for which information has been obtained by the obtaining unit and which is not registered in the OS, the control unit controls the registration unit so as to convert a format and thereby register the information of the color profile whose format has been changed.

7. The storage medium according to claim 6, wherein in a case where a result of the format conversion is successful, the control unit controls the registration unit so as to register, in the OS, the information of the color profile whose format has been changed.

8. The storage medium according to claim 6, wherein in a case where a result of the format conversion is unsuccessful, the control unit excludes the color profile for which the format conversion has been attempted from being a target of management by the printer driver.

9. The storage medium according to claim 2, wherein
a print queue corresponding to the printer driver is registered in the OS, and
in a case where the conditions are satisfied, the control unit controls the registration unit so as to register, in the OS, the information of the color profile obtained by the obtaining unit by re-registering the print queue.

10. The storage medium according to claim 9, wherein in a case where the print queue re-registration is performed, the control unit causes a display unit to display a procedure for the print queue re-registration.

11. The storage medium according to claim 9, wherein the print queue re-registration is performed by print queue deletion and print queue creation.

12. The storage medium according to claim 11, wherein when the print queue deletion is performed, the control unit moves out data created by a user from a first storage region managed by the OS to a second storage region not managed by the OS, and when the print queue creation is performed, the control unit restores the data from the second storage region to the first storage region.

13. The storage medium according to claim 9, the computer further being caused to function as: a decision unit configured to, in a case where the print queue corresponding to the printer driver is set to be a first print queue and a plurality of print queues including the first print queue are registered in the OS, decide whether to perform the print queue re-registration targeting the plurality of print queues or perform the print queue re-registration targeting only the first print queue.

14. The storage medium according to claim 13, wherein the decision unit makes the decision by receiving a selection from a user.

15. The storage medium according to claim 1, wherein the obtaining unit obtains, from a file defining setting information of the printer driver, the information of the color profile managed by the printer driver.

16. The storage medium according to claim 1, wherein the application is an application configured to obtain information related to a printing medium on which a printer can perform printing.

17. The storage medium according to claim 1, the computer further being caused to function as:
a determination unit configured to determine whether the information of the color profile obtained by the obtaining unit is registered in the OS,
wherein in a case where the determination unit determines that the information of the color profile obtained by the obtaining unit is not registered in the OS, the registration unit registers, in the OS, the information of the color profile.

18. The storage medium according to claim 17, wherein the determination unit determines whether the information of the color profile obtained by the obtaining unit is registered in the OS based on the information of the color profile obtained by the obtaining unit and information of a print queue registered in the OS.

19. An information processing apparatus comprising:
at least one memory and at least one processor which function as:
an obtaining unit configured to obtain information of a color profile managed by a printer driver;
a registration unit configured to register, in an operating system (OS), the information of the color profile obtained by the obtaining unit; and
a control unit configured to control the registration unit so as to change a method of registration in the OS based on the information of the color profile obtained by the obtaining unit.

20. A method executed in an information processing apparatus, the method comprising:
obtaining information of a color profile managed by a printer driver;
registering, in an operating system (OS), the obtained information of the color profile; and
controlling the registering so as to change a method of registration in the OS based on the obtained information of the color profile.
